(19) United States
(12) Patent Application Publication
(10) Pub. No.: US 2009/0004465 A1
(43) Pub. Date: Jan. 1, 2009

(54) Metal Film Formation Method of Metal Film

(75) Inventors: Takeyoshi Kano, Kanagawa (JP); Koichi Kawamura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Tokyo (JP)

(21) Appl. No.: 11/813,839

(22) PCT Filed: Jan. 13, 2006
(86) PCT No.: PCT/JP2006/300790

§ 371 Date: Jul. 12, 2007

(30) Foreign Application Priority Data
Jan. 13, 2005 (JP) 2005-006236

(51) Int. Cl. B32B 15/08; B32B 5/00; B05D 5/12; B05D 3/00; C25D 5/34

(52) U.S. Cl. 428/336; 428/457; 427/58; 427/532; 427/541; 205/183

(57) ABSTRACT

The present invention provides a metal film formed by applying an electroless plating catalyst or its precursor to a polymer layer on a base plate having a surface roughness of 500 nm or less and then carrying out electroless plating, the polymer layer containing a polymer which has a functional group capable of interacting with the electroless plating catalyst or its precursor and is chemically bonded directly to the base plate, wherein the adhesion strength between the base plate and the metal film is 0.2 kN/m or more.

### BACKGROUND OF THE INVENTION

1. Field of the Invention

The present invention relates to a metal film and a formation method of a metal film.

2. Description of the Related Art

A metal film formed on a base plate has been used for various electronic products by being pattern-wise etched. With respect to the metal film formed on the base plate (metal base plate), adhesion property between the base plate and the metal film is obtained by an anchor effect of surface-roughening treatment on the base plate. As a result, the base plate interface of the metal film formed becomes rough, and in the case of using the metal film as an electric wiring, a problem of deterioration of the high frequency property is caused. Further, at the time of forming the metal base plate, there is a problem that a complicated process of treating the base plate with a strong acid such as chromic acid is required for surface-roughening treatment.

To solve the problems, a method involving applying a coating solution containing monomers to a base plate, and irradiating electron beam or UV light to the coating solution to introduce a surface graft polymer on the base plate, followed by electroless plating to form a metal film is developed (refer to Japanese Patent Application Laid-Open (JP-A) No. 58-196238). In JP-A No. 58-196238, there are no detailed investigations about the state of the practical base plate surface and about the adhesion property of the base plate and the metal layer. Also, according to the method of the document, since the graft polymer is formed by applying the coating solution containing monomers to the base plate as it is and irradiating electron beam or UV light, it is thought that the amount of the surface graft polymer formed is small, and accordingly, it is thought that the adhesion strength between the base plate and the plated film (metal film) is low.

With respect to the method of improving the adhesion property of the base plate and the metal layer by introducing a graft polymer on the base plate, a method for improving the adhesion property between a polyimide base plate and a copper layer by carrying out plasma treatment on the polyimide base plate, introducing a polymerization initiating group on the surface of the polyimide base plate, polymerizing monomers from the polymerization initiating group to introduce a graft polymer on the base plate, and forming the metal layer (copper layer) on the graft polymer is disclosed (refer to En Tang Kang, Yan Zhang, “Advanced Materials”, 20, p 1481-p 1494 and N. Inagaki, S. Tasaka, M. Matsumoto, “Macromolecules”, 29, p 1642-p 1648). However, the method requires troublesome plasma treatment and thus development of a simpler method has been desired.

### SUMMARY OF THE INVENTION

The present invention has been made in view of the above-mentioned disadvantages of the conventional technologies, and aims to accomplish the following.

That is, it is an object of the invention to provide a metal film excellent in adhesion property to a base plate.

It is another object of the invention to provide a metal film formation method capable of forming a metal film excellent in adhesion property to a base plate and having a small roughness in the interface with the base plate by a simple process.

The inventors have made various investigations and consequently have found that a metal film excellent in adhesion property can be obtained, even if the roughness of the base plate interface is small, by chemically bonding a polymer having an electroless plating catalyst or its precursor directly to the base plate and then carrying out electroless plating on the polymer. The findings have now led to completion of the invention.

The metal film of the invention is a metal film formed by applying an electroless plating catalyst or its precursor to a polymer layer on a base plate having a surface roughness of 500 nm or less and then carrying out electroless plating, the polymer layer comprising a polymer which has a functional group capable of interacting with the electroless plating catalyst or its precursor and is chemically bonded directly to the base plate, wherein the adhesion strength between the base plate and the metal film is 0.2 kN/m or more.

The polymer layer preferably has a region containing, in an amount of 25% by volume or more, dispersed fine particles of at least one of the electroless plating catalyst and a metal deposited by the electroless plating, in a thickness of 0.05 μm or more in the direction from the interface between the polymer layer and the metal film toward the base plate.

The base plate is preferably a base plate made of an insulating resin having a dielectric loss tangent of 0.01 or less at 1 GHz or a base plate comprising a layer made of the insulating resin on a base material. The base plate is preferably a base plate made of an insulating resin having a dielectric constant of 3.5 or less at 1 GHz or a base plate comprising a layer made of the insulating resin on a base material.

The base material in the invention means a material to be a support for forming a metal pattern thereon, such as a polyimide film or the like.

The base plate in the invention means a plate onto which a graft polymer, which is described in detail below, can be chemically bonded directly. For example, in the case an intermediate layer such as a polymerization initiating layer is formed on a base material and then a graft polymer is formed thereon, the base plate includes the base material and the intermediate layer formed on the base material, and in the case the graft polymer is formed directly on the base material, the base plate means the base material itself.

The metal film formation method of the invention comprises the steps of: (a) introducing, on a base plate having a surface roughness of 500 nm or less, a polymer which has a functional group capable of interacting with an electroless plating catalyst or its precursor and is capable of being chemically bonded directly to the base plate; (b) applying the electroless plating catalyst or its precursor to the polymer; and (c) carrying out electroless plating.

The step (a) preferably comprises the steps of: (a-1) producing a base plate in which a polymerization initiating layer containing a polymerization initiator is formed on a base material having a surface roughness of 500 nm or less; and (a-2) introducing, on the base plate in which the polymerization initiating layer is formed, a polymer which has a functional group capable of interacting with an electroless plating catalyst or its precursor and is capable of being chemically bonded directly to the base plate.

The step (a-2) preferably comprises bringing a polymer which has a polymerizable group and a functional group capable of interacting with an electroless plating catalyst or its precursor into contact with the base plate in which the polymerization initiating layer is formed, followed by applying energy thereto to chemically bond the polymer directly to the entire surface of the base plate.

In the metal film formation method of the invention, there is an advantage that a metal pattern having a desired film thickness can be formed by the step of (d) carrying out electroplating after the step (c).

In the metal film formation method of the invention, it is preferable to carry out a drying step after the step (c) or the step (d).

The mechanism of the invention is not so clear, however is thought to be as follows.

The base plate on which the metal film is formed in the invention is a smooth base plate having a base plate surface roughness of 500 nm or less. However, it is thought that surface modification by the surface graft leads to formation of a hybrid state between the base plate interface of the metal film and the polymer bonded directly to the base plate, and therefore, even if the base plate surface is smooth, the high adhesion property between the metal film and the base plate is obtained.

Further, the graft polymer formed in the metal film formation method of the invention is formed by polymerization from the base plate interface, and therefore, it is thought that the polymer has high mobility and is easily interacted with the electroless plating catalyst or its precursor. Further, it is thought that owing to the high mobility of the graft polymer, an electroless plating solution easily penetrates the inside of the formed surface graft layer and thus the electroless plating proceeds in the inside and the upper part of the surface graft layer, whereby the hybrid state is easily formed between the metal film and the polymer directly bonded to the base plate, which contributes to the improvement in adhesion property between the metal film and the base plate.

Further, the preferable embodiment of the metal film formation method of the invention is an embodiment in which a polymerization initiating layer containing a polymerization initiator is formed on a base material. In this embodiment, since a polymerization initiating layer containing a polymerization initiator is formed on a base material, it is thought that the amount of radical species generated on the surface of the base plate is increased only by irradiating a commonly employed exposure light source such as UV light and thereby a larger amount of a graft polymer can be produced, so that the hybrid state of the metal film and the graft polymer is easily formed and the adhesion property between the base plate and the metal film is further improved.

Further, a preferable embodiment of the metal film formation method of the invention is an embodiment comprising bringing a polymer which has a polymerizable group and a functional group capable of interacting with an electroless plating catalyst or its precursor into contact with the surface of the polymerization initiating layer, followed by applying energy to chemically bond the polymer directly to the base plate. A common graft polymerization method involves immersing, in a monomer solution, a base plate in which a polymerization initiating layer is formed, and applying energy. However, mass production is difficult in this technique. Also, a method of applying a monomer solution to the base plate and applying energy is also known, however since the monomer is in liquid form, it is very difficult to keep the monomer uniformly on the base plate and the surface roughness after grafting is degraded. On the other hand, in the case of using a polymer having a polymerizable group and a functional group capable of interacting with the electroless plating catalyst or its precursor, since it is possible to form the coating film on the base plate in which the polymerization initiating layer is formed and then apply energy, mass production is made possible, and since the polymer is in solid form, the film formation can be carried out uniformly.

### BRIEF DESCRIPTION OF THE DRAWINGS

FIG. 1 is a SEM photograph of a cross sectional view of a metal film 2 obtained in Example 2.

FIG. 2 is an image obtained by carrying out image processing (two tone processing) of the SEM photograph of the cross-sectional view in FIG. 1 for making the particle portions white and polymer portions black.

### DETAILED DESCRIPTION OF THE INVENTION

Hereinafter, the present invention will be described in detail.

### [Metal Film]

A metal film of the invention is a metal film formed by applying an electroless plating catalyst or its precursor to a polymer layer on a base plate having a surface roughness of 500 nm or less and then carrying out electroless plating, the polymer layer comprising a polymer which has a functional group capable of interacting with the electroless plating catalyst or its precursor and is chemically bonded directly to the base plate, wherein the adhesion strength between the base plate and the metal film is 0.2 kN/m or more. That is, although the surface of the base plate is not roughened and thus is smooth, the adhesion property between the base plate and the metal film is excellent.

The surface roughness of the base plate in the invention is 500 nm or less, preferably 100 nm or less, more preferably 50 nm or less, and even more preferably 20 nm or less.

If the surface roughness of the base plate is in the above-mentioned range, when using the metal film of the invention for wiring or the like, electric loss is suppressed at the time of high frequency electric transmission.

Rz (10-point mean roughness) of the surface of the base plate is 450 nm or less, preferably 80 nm or less, more preferably 40 nm or less, and even more preferably 15 nm or less. The Rz is measured, according to JIS B0601, as the difference between the average value of Z data of from the first maximum to the fifth maximum summits and the average value of from the first minimum to the fifth minimum valleys on an appointed face.

The metal film of the invention has an adhesion strength of 0.2 kN/m or more between the base plate and the metal film. Although there is no upper limit of the adhesion strength, typically, it is about 0.2 to 2.0 kN/m. With respect to a conventional metal film, the adhesion strength between the base plate and the metal film is generally in a range of 0.2 to 3.0 kN/m. Accordingly, it can be understood that the metal film of the invention has a sufficient adhesion strength for practical use.

Further, in the invention, the polymer layer existing between the metal film and the base plate preferably has a region containing, in an amount of 25% by volume or more, dispersed fine particles of at least one of the electroless plating catalyst and a metal deposited by the electroless plating, in a thickness of 0.05 μm or more in the direction from the interface between the polymer layer and the metal film toward the base plate.

The state of the fine particles existing in the polymer layer is described more in detail: in the polymer layer (graft film), in the direction from the interface between the polymer layer and the metal film toward the base plate, at the interface side of the polymer layer, fine particles containing an electroless plating catalyst and/or a metal deposited by the electroless plating are dispersed at high density. In this dispersion state of the fine particles, from the viewpoint of obtaining the adhesion strength of the metal film, it is preferable that there is a region containing the fine particles in an amount of 25% by volume or more in the periphery of the interface between the metal film and the polymer layer. The amount is more preferably at least 30% by volume, furthermore preferably at least 40% by volume, and even more preferably at least 50% by volume. In the polymer layer, the region where the fine particles exist at such a high density exists preferably in a depth of 0.05 μm or more, more preferably 0.1 μm or more, furthermore preferably 0.2 μm or more, and even more preferably 0.3 μm or more in the direction from the interface between the polymer layer and the metal film toward the base plate.

Generally, with respect to the metal film, a metal pattern excellent in high frequency property can be obtained by controlling the roughness at the interface with the base plate to be 500 nm or less and carrying out pattern-wise etching. Herein, the high frequency property means particularly the property of lowering the transmission loss and further the property of lowering conductor loss in the transmission loss.

In this connection, with respect to a conventional metal film, if the surface roughness of the base plate is lowered, the adhesion property between the base plate and the metal film is degraded. Therefore, the surface of the base plate has to be roughened by various manners and the metal film is formed thereon. Accordingly, the roughness at the interface between the conventional metal film and base plate is generally 2000 nm or more.

On the other hand, the metal film of the invention is enabled to maintain the excellent adhesion property because the base plate interface is in the hybrid state of the metal film and the polymer layer chemically bonded directly to the base plate.

As described above, it is possible that in the metal film of the invention, the roughness at the interface with the base plate is suppressed to the minimum level, and at the same time, the adhesion property between the base plate and the metal film is maintained.

The metal film of the invention can be used as an electromagnetic wave preventive film and for a variety of use such as semiconductor chips, various electric wiring boards, FPC, COF, TAB, antennas, multilayered wiring boards, mother boards by patterning the metal film by etching.

The metal film of the invention can be produced by the metal film formation method of the invention as described below. Hereinafter, the metal film formation method of the invention will be described in detail.

### [Metal Film Formation Method]

The metal film formation method of the invention comprises the steps of: (a) introducing, on a base plate having a surface roughness of 500 nm or less, a polymer which has a functional group capable of interacting with an electroless plating catalyst or its precursor and is capable of being chemically bonded directly to the base plate; (b) applying the electroless plating catalyst or its precursor to the polymer; and (c) carrying out electroless plating.

Hereinafter, the above-mentioned respective steps (a) to (c) will be described successively.

[Step (a)]

In the step (a), on a base plate having a surface roughness of 500 nm or less, a polymer which has a functional group capable of interacting with an electroless plating catalyst or its precursor (hereinafter, often referred to as interacting group) and is capable of being chemically bonded directly to the base plate is introduced.

The step (a) in the invention preferably comprises the steps of: (a-1) producing a base plate in which a polymerization initiating layer containing a polymerization initiator is formed on a base material having a surface roughness of 500 nm or less; and (a-2) introducing, on the base plate in which the polymerization initiating layer is formed, a polymer which has a functional group capable of interacting with an electroless plating catalyst or its precursor and is capable of being chemically bonded directly to the base plate.

The above-mentioned step (a-2) preferably comprises bringing a polymer which has a polymerizable group and a functional group capable of interacting with an electroless plating catalyst or its precursor into contact with the base plate in which the polymerization initiating layer is formed, followed by applying energy thereto to chemically bond the polymer directly to the entire surface of the base plate.

### (Surface Graft)

The polymer is introduced onto the surface of the base plate by means of generally-used so-called surface graft polymerization in the present invention. Graft polymerization is a method of preparing a graft polymer by adding an active species to a polymer compound chain and allowing it to polymerize with another monomer that initiates polymerization. In particular, when the polymer compound providing the active species is present on a solid surface, it is called surface graft polymerization.

Methods of the surface graft polymerization to be applied to the present invention include any known methods described in literature. Examples thereof include the photo-graft polymerization methods and plasma irradiation graft polymerization methods described in New Polymer Experimental Studies vol. 10 (Soc. Polymer Science Japan Ed., 1994, Kyoritsu Shuppan Co., Ltd., p. 135). In addition, examples thereof also include radiation irradiation graft polymerization methods of using γ ray or electron beam described in Handbook of Absorption Technology (NTS., Takeuchi Ed., February 1999, p. 203 and 695).

Specific examples of the photo-graft polymerization methods include the methods described in JP-A Nos. 63-92658, 10-296895, and 11-119413.

In addition to these methods above, the methods for preparing the surface graft layer which has a direct chemical bonding of a terminal of a polymer compound chain include a method of introducing a reactive functional group such as a trialkoxysilyl group, isocyanate group, amino group, hydroxyl group, or carboxyl group to a terminal of a polymer compound chain and causing a coupling reaction between the functional group and the functional group present on the base plate surface.

Among these methods, a photo-graft polymerization method is preferable from the viewpoint of generating more surface graft polymers.

The base plate surface according to the present invention is a surface to which a terminal of a polymer compound having an interacting group can be chemically bonded directly or via a backbone polymer compound, and the base material may have such a surface property as it is, or an intermediate layer separately formed on the base material may have such a property.

Also, the method for preparing a surface to which a terminal of a polymer compound chain having an interacting group is chemically bonded through a backbone polymer compound may be a method of synthesizing a polymer compound having a functional group capable of causing coupling reaction with the functional group on the surface of the base plate and an interacting group, and successively forming the surface by coupling reaction of the polymer compound and the functional group on the surface of the base plate. Another method is, in the case the base plate surface has a property of generating radical species, a method of synthesizing a polymer compound having a polymerizable group and an interacting group, applying the polymer compound to the base plate surface, generating radical species, and causing polymerization reaction of the base plate surface and the polymer compound.

In the invention, as described above, the active species is generated on the base plate surface and a graft polymer is formed using the species as a starting point. When the graft polymer is formed, it is preferable to form a polymerization initiating layer containing a polymerization initiator on a base material having a surface roughness of 500 nm or less [the step (a-1)] from the viewpoint of efficient generation of the active centers and formation of a larger amount of the surface graft polymer.

The polymerization initiating layer is preferably formed as a layer containing a polymerizable compound and a polymerization initiator.

The polymerization initiating layer in the invention may be formed by dissolving needed components in a solvent capable of dissolving them therein, providing the components on the base plate surface by coating or the like, and curing by heating or irradiating light.

### (a) Polymerizable Compound

The polymerizable compound to be used for the polymerization initiating layer is not particularly limited as long as it has a good adhesion property with the base material and is capable of forming a surface graft polymer by applying energy such as activation light beam irradiation. As the polymerizable compound, a polyfunctional monomer may be used, and a hydrophobic polymer having a polymerizable group in a molecule is particularly preferably used.

Examples of the hydrophobic polymer include a homopolymer of a diene such as polybutadiene, polyisoprene, and polypentadiene; a homopolymer of an allyl group-containing monomer such as allyl (meth)acrylate, 2-allyloxyethyl methacrylate; a binary or multi-component copolymer of styrene, (meth)acrylic acid ester, (meth)acrylonitrile, or the like, which contains a diene type monomer such as butadiene, isoprene, and pentadiene, or an allyl group-containing monomer as a constituent unit; and a linear polymer or three-dimensional polymer having a carbon-carbon double bond in a molecule such as unsaturated polyesters, unsaturated polyepoxides, unsaturated polyamides, unsaturated acrylic polymers, and high density polyethylenes.

In this specification, the word “(meth)acrylic” may be used for both or one of acrylic and methacrylic.

The content of the polymerizable compound in the polymerization initiating layer is preferably 0 to 100% by mass and more preferably 10 to 80% by mass based on the solid content of the polymerization initiating layer.

### (b) Polymerization Initiator

The polymerization initiating layer contains a polymerization initiator for allowing initiation of polymerization by application of energy. The polymerization initiator used can be suitably selected from known thermal polymerization initiators, photopolymerization initiators and the like that allow initiation of polymerization by application of certain energy, for example, by irradiation of activation light, heating, irradiation of electron beam, or the like, according to applications. Among these polymerization initiators, use of a photopolymerization initiator is preferable because use of photopolimerization is preferable from the point of productivity.

The photopolymerization initiator is not particularly limited, as long as it can be activated by the activation light irradiated and can conduct surface polymerization, for example, a radical polymerization initiator, anion polymerization initiator, cation polymerization initiator or the like may be used, and a radical polymerization initiator is preferable from the viewpoint of reactivity.

Specific examples of the photopolymerization initiators include acetophenones such as p-tert-butyltrichloroacetophenone, 2,2′-diethoxyacetophenone, and 2-hydroxy-2-methyl-1-phenylpropane-1-one; ketones such as benzophenone, 4,4′-bisdimethylaminobenzophenone, 2-chlorothioxanthone, 2-methylthioxanthone, 2-ethylthioxanthone, and 2-isopropylthioxanthone; benzoin ethers such as benzoin, benzoin methylether, benzoin isopropylether, and benzoin isobutylether; benzyl ketals such as benzyldimethylketal and hydroxycyclohexylphenylketone; and the like.

The content of the polymerization initiator is preferably in the range of 0.1 to 70% by mass and more preferably in the range of 1 to 40% by mass with respect to the solid matters in the polymerization initiating layer.

The solvent for use in application of the polymerizable compound and polymerization initiator is not particularly limited as long as it can dissolve these components. From the points of easiness in drying and workability, the solvent preferably does not have an excessively high boiling point, and more specifically, a solvent having a boiling point of about 40 to 150° C. is preferable.

Specific examples thereof include acetone, methylethylketone, cyclohexane, ethyl acetate, tetrahydrofuran, toluene, ethylene glycol monomethylether, ethylene glycol monoethylether, ethylene glycol dimethylether, propylene glycol monomethylether, propylene glycol monoethylether, acetylacetone, cyclohexanone, methanol, ethanol, 1-methoxy-2-propanol, 3-methoxypropanol, diethylene glycol monomethylether, diethylene glycol monoethylether, diethylene glycol dimethylether, diethylene glycol diethylether, propylene glycol monomethylether acetate, propylene glycol monoethylether acetate, 3-methoxypropyl acetate, and the like.

These solvents may be used alone or in combination. The concentration of solid matters in the coating solution is preferably 2 to 50% by mass.

The coating amount when a polymerization initiating layer is formed on a base plate is preferably 0.1 to 20 g/m² and more preferably 1 to 15 g/m² as dry mass, for the purpose of allowing initiation of polymerization sufficiently and preventing layer exfoliation while maintaining the layer properties.

In the present invention, as described above, a polymerization initiating layer is formed on a base material surface by applying the composition for forming the polymerization initiating layer and then removing the solvent, and it is preferable to harden the layer by heating and/or photoirradiation at the same time. In particular, it is preferable to dry the layer by heating and subsequently harden the layer partially by photoirradiation, which allows hardening of the polymerizable compound to some extent, for effective prevention of such troubles as exfoliation of the entire polymerization initiating layer after the completion of the graft reaction. The reason for the use of photoirradiation for the partial hardening is the same as that described in the section of the photopolymerization initiator. The temperature and the period of heating may be suitably selected in the range of conditions that allow sufficiently removal of the coating solvent, but the temperature is preferably 100° C. or less and the drying time is 30 minutes or less, and further, the heating condition of a drying temperature of 40 to 80° C. and a drying time of 10 minutes or less is more preferable from the viewpoint of productivity.

The light source for use in the graft reaction described below may also be used for the photoirradiation conducted as needed after the heat drying. In order not to inhibit the bond formation between the active center on the polymerization initiating layer and the graft chain by application of energy in the subsequent graft reaction, it is preferable to conduct photoirradiation to an extent that allows only partial but not complete radical polymerization of the polymerizable compound present in the polymerization initiating layer. The photoirradiation time may vary according to the strength of the light source used, but is generally preferably 30 minutes or less. The rough standard for the partial hardening is a layer residual ratio after solvent washing of 10% or less and an initiator residual ratio after partial hardening of 1% or more.

### (Base Material)

The base material for use in the invention preferably has a dimensional stability and is a plate-shaped material. Examples thereof include papers, papers laminated with plastic (e.g., polyethylene, polypropylene, polystyrene), metal plates (e.g., aluminum, zinc, copper, etc.); plastic films (e.g., cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, polyvinylacetal, polyimide, epoxy resins, etc.); papers or plastic films on which the above-described metal is laminated or vapor deposited; and the like. A polyester or polyimide film is preferable as the base material for use in the invention.

Further, the metal film of the present invention can be applied to semiconductor packages, various electric wiring base plates, etc. by forming a pattern using etching. When the metal film is used in such an application, it is preferable to use an insulating resin as a base plate as described below.

Examples of the insulating resin include resins such as polyphenylene ether or denatured polyphenylene ether, cyanate ester compounds, and epoxy compounds. Use of a base plate formed by a thermosetting resin composition containing at least one of these resins is preferable. When at least two of these resins are combined for forming the resin composition, preferable examples of the combination of resins include: a combination of polyphenylene ether or denatured polyphenylene ether and cyanate ester compounds, that of polyphenylene ether or denatured polyphenylene ether and epoxy compounds, and that of polyphenylene ether or denatured polyphenylene ether and cyanate ester compounds and epoxy compounds.

When the base plate is formed by using the thermosetting resin compositions, use of the thermosetting resin compositions without containing inorganic fillers selected from the group consisting of silica, talc, aluminum hydroxide, and magnesium hydroxide is preferable, and use of the thermosetting resin compositions containing bromine compounds or phosphorous compounds is also preferable.

Examples of other insulating resins include a 1,2-bis(vinyl phenylene) ethane resin or a denatured resin of a polyphenylene ether resin and the 1,2-bis(vinyl phenylene) ethane resin. Further details of this resin are described in “Journal of Applied Polymer Science” Satoru Amaba et al, vol. 92, pp. 1252 to 1258 (2004).

Further, preferable examples of other insulating resins include a liquid crystal polymer commercially available as a product name “Vecster” (manufactured by Kuraray Co., Ltd.) or fluororesin such as polytetrafluoroethylene (PTFE) as a typical example.

Among these resins, polytetrafluoroethylene (PTFE) is a material having the most excellent high frequency property among polymer materials. However, since PTFE is a thermoplastic resin having low Tg, and has poor dimensional stability with respect to heat, PTFE is worse than a thermosetting resin material in mechanical strength. PTFE also has a problem of being inferior in formability and workability. Further, a thermoplastic resin such as polyphenylene ether (PPE) can be used in alloy with a thermosetting resin. Examples of the alloy include: an alloy resin of PPE and an epoxy resin, that of PPE and triallylisocyanate or that of a PPE resin having a polymerizable functional group introduced therein and other thermosetting resins.

Epoxy resin itself does not exhibit sufficient dielectric characteristics. However, by introduction of bulky skeleton or the like, epoxy resins are intended to be improved. In this way, use of resins in which the respective characteristics are made the best use of, a structure for compensating their drawbacks is introduced thereinto, and denaturation is adopted is preferable.

For example, among thermosetting resins, although cyanate ester is a resin having the most excellent dielectric characteristics, cyanate ester is not often used singly but used as a denatured resin of an epoxy resin, a maleimide resin or a thermoplastic resin. Details thereof are described in “Electronic technology” No. 9, pp. 35 (2002), and these descriptions can be also referred to when the insulating resin is selected.

When a metal film of the present invention is applied to semiconductor packages, various electric wiring, etc., from the viewpoint of processing of mass storage data at high speed, in order to reduce delay and damping of signals, it is effective to decrease dielectric constant and dielectric loss tangent of the base plate. Use of low dielectric loss tangent materials is exactly as described in “Electronics Packaging Institutional Journal” vol. 7, No. 5, pp. 397 (2004). From the viewpoint of data processing at high speed, use of insulating materials having low dielectric loss tangent characteristics is particularly preferable.

Specifically, it is preferable that the base plate in the invention is a base plate made of an insulating resin whose dielectric constant, i.e. relative dielectric constant, is 3.5 or less at 1 GHz, or a base plate comprising a layer made of the insulating resin on a base material. Also, it is preferable that the base plate in the invention is a base plate made of an insulating resin whose dielectric loss tangent is 0.01 or less at 1 GHz or a base plate comprising a layer made of the insulating resin on a base material. The dielectric constant and dielectric loss tangent of the insulating resin can be determined by a conventional method, for example, a method described in the Abstracts of 18^{th} JIEP Annual Meeting, 2004, p 189, in which a cavity resonator perturbation method (for example, εr, tan δ measuring apparatus for ultrathin sheet manufactured by Keycom Co., Ltd) is used.

Thus, in the invention, it is useful to select the insulating resin in light of dielectric constant and dielectric loss tangent. Examples of an insulating resin having a dielectric constant of 3.5 or less and a dielectric loss tangent of 0.01 or less include a liquid crystal polymer, polyimide resin, fluororesin, polyphenylene ether resin, cyanate ester resin, bis(bisphenylene) ethane resin and the like, and further include modified resins thereof.

The surface roughness of the base plate to be employed for the metal film formation method of the invention is 500 nm or less, preferably 100 nm or less, more preferably 50 nm or less, and even more preferably 20 nm or less.

Rz (10-point mean roughness) of the surface of the base plate is 500 nm or less, preferably 100 nm or less, more preferably 50 nm or less, and even more preferably 20 nm or less.

The surface roughness of the base material to be employed for the metal film formation method of the invention is 500 nm or less, preferably 100 nm or less, more preferably 50 nm or less, and even more preferably 20 nm or less.

Rz (10-point mean roughness) of the surface of the base material is 500 nm or less, preferably 100 nm or less, more preferably 50 nm or less, and even more preferably 20 nm or less.

The Rz is measured, according to JIS B0601, as the difference between the average value of Z data of from the first maximum to the fifth maximum summits and the average value of from the first minimum to the fifth minimum valleys on an appointed face.

### (Formation of Graft Polymer)

With respect to the embodiment of graft polymer formation in the step (a), as described above, a method of utilizing coupling reaction of the functional group existing on the base plate surface and the reactive functional group which the polymer compound has in the terminals or the side chains, or a method of carrying out photograft polymerization of the base plate directly can be used.

In the invention, the embodiment [the step (a-2)] of introducing, on the base plate in which the polymerization initiating layer is formed, a polymer which has a functional group (interacting group) capable of interacting with an electroless plating catalyst or its precursor and is capable of being chemically bonded directly to the base plate is preferable. Further, the embodiment of bringing a polymer which has a polymerizable group and a functional group (interacting group) capable of interacting with an electroless plating catalyst or its precursor into contact with the base plate in which the polymerization initiating layer is formed, followed by applying energy thereto to chemically bond the polymer directly to the entire surface of the base plate is more preferable. That is, a composition containing the compound having the polymerizable group and the interacting group is brought into contact with the base plate surface having the polymerization initiating layer, and at the same time, is bonded to the base plate surface by the active species generated on the base plate surface.

The above-mentioned contact may be carried out by immersing the base plate into a liquid state composition containing the compound having the polymerizable group and the interacting group, however, from the viewpoint of the handling property and the production efficiency, as described later, the layer containing the composition containing the compound having the polymerizable group and the interacting group as a main component may be formed on the base plate surface by a coating method.

<Method of Utilizing Coupling Reaction of the Functional Group Existing on the Base Plate Surface and the Reactive Functional Group which the Polymer Compound has in the Terminals or Side Chains>

In the invention, the coupling reaction to be employed for forming the graft polymer may be any reactions. The combinations of the functional group of the base plate surface and the reactive functional group which the polymer compound has in the terminals or side chains may be (—COOH, amine), (—COOH, azilidine), (—COOH, isocyanate), (—COOH, epoxy), (—NH₂, isocyanate), (—NH₂, aldehydes), (—OH, alcohol), (—OH, a halogenated compound), (—OH, amine), and (—OH, acid anhydride). From the viewpoint of high reactivity, (—OH, polyisocyanate) and (—OH, epoxy) are particularly preferable combinations.

### <Method of Direct Photo-Graft Polymerization of the Base Plate>

### (Monomer Having the Interacting Group and Undergoing Photo-Graft Polymerization)

In the invention, examples of the compound which has the interacting group and is capable of being chemically bonded directly to the base plate, and is used for forming the graft polymer by direct photo-graft polymerization of the base plate may include the following monomers, e.g. monomers having functional groups such as carboxyl group, sulfonic acid group, phosphoric acid group, amino group and their salts, hydroxy group, amido group, phosphine group, imidazole group, pyridine group and their salts, and ether group. Specific examples thereof include (meth)acrylic acid and its alkali metal salts and amine salts; itaconic acid and its alkali metal salts and amine salts; 2-hydroxyethyl (meth)acrylate, (meth)acrylamide, N-monomethylol (meth)acrylamide, N-dimethylol (meth)acrylamide, and allylamine and allylamine hydrohalides, 3-vinylpropionic acid and its alkali metal salts and amine salts; vinylsulfonic acid and its alkali metal salts and amine salts; 2-sulfoethyl (meth)acrylate, polyoxyethylene glycol mono (meth)acrylate, 2-acrylamido-2-methylpropanesulfonic acid, acid phosphoxy polyoxyethylene glycol mono(meth)acrylate, and N-vinylpyrrolidone (the following structure). These monomers may be used alone or in combination of two or more kinds of them.

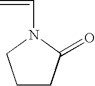

### (Polymer Having the Interacting Group and Capable of Being Chemically Bonded Directly to the Base Plate)

The polymer having the interacting group and capable of being chemically bonded directly to the base plate in the invention may be polymers formed from monomers having interacting groups. Polymers obtained by introducing ethylene addition polymerizable unsaturated groups (polymerizable groups) such as vinyl group, allyl group, (meth)acrylic group as the polymerizable group into homopolymers or copolymers obtained by using at least one kind of monomers having the interacting groups, that is, polymers having the polymerizable groups and interacting groups are more preferably used. The polymers having the polymerizable groups and interacting groups include at least polymerizable group in the terminals or in the side chains, and the polymers having the polymerizable groups in the terminals are more preferable, and those having polymerizable groups in the terminals and side chains are even more preferable.

As described above, the polymers having the polymerizable groups and interacting groups are used preferably in the invention because of the following reasons. That is, in consideration of the workability in the case of graft polymerization using monomers, mass production is difficult by the method of immersion in a monomer solution. Also, it is also very difficult for a method of applying a monomer solution to keep the monomer solution uniformly on the base plate until photoirradiation. Further, although a method of covering the monomer solution with a film or the like after application is known, it is difficult to cover the solution uniformly and the work is complicated since the covering work is required. On the other hand, in the case of using the polymer, the polymer becomes a solid after application and therefore, uniform film formation is made possible and the mass production is also easy.

The monomers having the interacting groups for synthesizing the above-mentioned polymers may be the following monomers. Examples thereof include monomers having functional groups such as carboxyl group, sulfonic acid group, phosphoric acid group, amino group and their salts, hydroxy group, amido group, phosphine group, imidazole group, pyridine group and their salts, and ether group. Specific examples thereof include (meth)acrylic acid or its alkali metal salts and amine salts; itaconic acid and its alkali metal salts and amine salts; 2-hydroxyethyl (meth)acrylate, (meth)acrylamide, N-monomethylol (meth)acrylamide, N-dimethylol (meth)acrylamide, and allylamine and allylamine hydrohalides, 3-vinylpropionic acid and its alkali metal salts and amine salts; vinylsulfonic acid and its alkali metal salts and amine salts; 2-sulfoethyl (meth)acrylate, polyoxyethylene glycol mono (meth)acrylate, 2-acrylamido-2-methylpropanesulfonic acid, acid phosphoxy polyoxyethylene glycol mono(meth)acrylate, and N-vinylpyrrolidone (the following structure). These monomers may be used alone or in combination of two or more kinds of them.

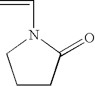

The polymers having the polymerizable groups and the interacting groups may be synthesized as follows.

Examples of the synthesis method may be i) a method of copolymerizing a monomer having the interacting group and a monomer having the polymerizable group; ii) a method of copolymerizing a monomer having the interacting group and a monomer having a double bond precursor and then introducing double bond by treatment with a base or the like; and iii) a method of reacting a polymer having the interacting group and a monomer having the polymerizable group and thereby introducing the double bond (introducing the polymerizable group). From the viewpoint of the synthesis suitability, the method ii) of copolymerizing a monomer having the interacting group and a monomer having a double bond precursor and then introducing double bond by treatment with a base or the like, and the method iii) of reacting a polymer having the interacting group and a monomer having the polymerizable group and thereby introducing the polymerizable group are preferable.

The monomer having the interacting group to be used for the synthesis of the polymer having the polymerizable group and the interacting group may be monomers similar to the above exemplified monomers having the interacting groups. The monomers may be used alone or in combination of two or more of them.

The monomer having the polymerizable group to be copolymerized with the monomer having the interacting group may be allyl (meth)acrylate and 2-allyloxyethyl methacrylate.

The monomer having the double bond precursor may be 2-(3-chloro-1-oxopropoxy)ethyl methacrylate and 2-(3-bromo-1-oxopropoxy)ethyl methacrylate.

The monomer having the polymerizable group to be utilized for introducing an unsaturated group by reaction with the functional group such as carboxyl group, amino group and its salts, hydroxyl and epoxy group in the polymer having the interacting group may be (meth)acrylic acid, glycidyl (meth)acrylate, ally glycidyl ether, and 2-isocyanatoethyl (meth)acrylate.

In the invention, a macromonomer can also be used. The methods for producing the macromonomer used in the invention may be, for example, various methods described in Chapter 2, “Synthesis of Macromonomers” of “Chemistry and Industry of Macromonomers” (Ed., Yuya Yamashita) published by Industrial Publishing & Consulting, Inc., Sep. 20, 1989. Particularly favorable examples of the macromonomers used in this embodiment include macromonomers derived from a carboxyl group-containing monomer such as acrylic acid or methacrylic acid; sulfonic acid type macromonomers derived from monomers such as 2-acrylamide-2-methylpropanesulfonic acid, vinylstyrenesulfonic acid, and the salts thereof; amide type macromonomers derived from monomers such as (meth)acrylamide, N-vinylacetamide, N-vinylformamide, and N-vinylcarboxylic acid amide; macromonomers derived from hydroxyl group-containing monomers such as hydroxyethyl methacrylate, hydroxyethyl acrylate, and glycerol monomethacrylate; macromonomers derived from alkoxy group- or ethylene oxide group-containing monomers such as methoxyethyl acrylate, methoxy polyethylene glycol acrylate, and polyethylene glycol acrylate; and the like. In addition, macromonomers having a polyethylene glycol chain or a polypropylene glycol chain may also be used effectively as the macromonomer used in the invention.

The favorable molecular weight of these macromonomers is in the range of 250 to 100,000 and particularly preferably in the range of 400 to 30,000.

The solvent to be used for the composition containing the monomer having the interacting group and polymer having the polymerizable group and the interacting group is not particularly limited as long as it can dissolve the monomer having the interacting group and the compound having the polymerizable group and the interacting group, which are main components in the composition. The solvent may further be mixed with a surfactant.

Usable solvents are, for example, alcohol type solvents such as methanol, ethanol, propanol, ethylene glycol, glycerin, propylene glycol monomethyl ether; acids such as acetic acid; ketone type solvents such as acetone and cyclohexanone; and amide type solvents such as formamide and dimethyl acetamide.

The surfactant, which is added to the solvent as needed is not particularly limited as long as it is soluble in the solvent, and examples of the surfactants include anionic surfactants such as sodium n-dodecylbenzenesulfonate; cationic surfactants such as n-dodecyltrimethylammonium chloride; nonionic surfactants such as polyoxyethylene nonylphenol ether (commercial product: e.g., Emulgen 910, manufactured by Kao Corporation), polyoxyethylene sorbitan monolaurate (commercial product: e.g., brand name “Tween 20”), and polyoxyethylene laurylether; and the like.

These surfactants may be used freely if the composition is applied as a liquid. When an interacting group containing composition coated layer is formed by a coating method, the coating amount is preferably 0.1 to 10 g/m² and more preferably 0.5 to 5 g/m² as solid matter, from the viewpoint of obtaining sufficient interaction with the plating catalyst or precursor thereof and obtaining a uniform coated layer.

### (Energy Application)

The method of applying energy to the base plate surface may be carried out by using radiant rays such as heat or light. For example, light irradiation using a UV lamp or visible light rays, and heating by a hot plate are available. The light source to be employed may be, for example, a mercury lamp, a metal halide lamp, a xenon lamp, a chemical lamp, and a carbon arc lamp. Also, g-ray and i-ray may be used. Although it differs depending on the production amount of the aimed graft polymer and the light source, the time taken to apply the energy is generally in a range of 10 seconds to 5 hours.

By the step (a) as described above, the polymer (graft polymer) having the interacting group can be introduced onto the base plate.

[Step (b)]

In the step (b), an electroless plating catalyst or its precursor is applied to the polymer having the interacting group and introduced onto the base plate by the step (a).

### <Electroless Plating Catalyst>

The electroless plating catalyst used in this step is mainly a O-valent metal of Pd, Ag, Cu, Ni, Al, Fe, Co, or the like. In the invention, Pd and Ag are particularly preferable as they are easier in handling and higher in catalytic activity. Methods of fixing the O-valent metal in the interaction region include, for example, a method of applying, to the graft polymer, a metal colloid in which charge is adjusted so as to interact with the interacting group of the graft polymer. Generally, metal colloids can be prepared by reducing a metal ion in a solution containing a charged surfactant or charged protecting agent. The charge of the metal colloids can be adjusted by the surfactant or protecting agent used here, and when allowing the metal colloid in which charge is thus adjusted to interact with the interacting group of the graft polymer, since the interacting group is mainly a polar group, the metal colloid (electroless plating catalyst) is selectively absorbed on the graft polymer.

### <Electroless Plating Catalyst Precursor>

The electroless plating catalyst precursor used in this step is not particularly limited as long as it can become an electroless plating catalyst in a chemical reaction. Metal ion of the 0-valent metal used as the electroless plating catalyst is commonly used. The electroless plating catalyst precursor, metal ion, is converted in a reduction reaction to the electroless plating catalyst, 0-valent metal. The electroless plating catalyst precursor, metal ion, may be converted to the electroless plating catalyst, 0-valent metal, in a separate reduction step after addition to the base plate and before immersion in an electroless plating bath, or alternatively, the electroless plating catalyst precursor may be immersed in an electroless plating bath as it is and converted to the metal (electroless plating catalyst) by a reducing agent present in the electroless plating bath.

Practically, the electroless plating catalyst precursor metal ion is added onto the graft pattern in the form of a metal salt. The metal salt used is not particularly limited as long as it is dissolved in a suitable solvent to afford a metal ion and a base (anion), and examples thereof include M(NO₃)ₙ, MClₙ, M_{2/n}(SO₄), M_{3/n}(PO₄) (M is an n-valent metal atom), and the like. The metal ion, which is preferably used, is formed by dissociation of the above-described metal salt. Specific examples thereof include Ag ion, Cu ion, Al ion, Ni ion, Co ion, Fe ion, Pd ion, and the like, and Ag and Pd ions are preferable from the point of catalytic activity.

The method of adding a metal colloid (electroless plating catalyst) or a metal salt (electroless plating catalyst precursor) onto the graft polymer may be a method of: dispersing a metal colloid in a suitable dispersion medium or dissolving a metal salt in a suitable solvent to prepare a solution containing a dissociated metal ion; and applying the solution onto the base plate surface having the graft polymer or immersing the base plate having the graft polymer in the solution. Contact of the solution containing a metal ion allows adsorption of the metal ion on the interacting group in the interaction region by an ion-ion or dipole-ion interaction, or impregnation of the metal ion into the interaction region. In order to achieve such an adsorption or impregnation to a satisfactory extent, the concentration of the metal ion or salt in the contact solution is preferably in the range of 0.01 to 50% by mass and more preferably 0.1 to 30% by mass. In addition, the contact time is preferably about 1 minute to 24 hours and more preferably about 5 minutes to 1 hour.

[Step (c)]

In the step (c), electroless plating is carried out on the polymer (graft polymer) to which the electroless plating catalyst or its precursor is added, whereby a high density metal film is formed on the base plate having the graft polymer formed thereon. The formed metal film has excellent electroconductivity and adhesion property.

### <Electroless Plating>

Electroless plating is an process of depositing a metal in a chemical reaction by using a solution containing the metal ion to be deposited.

The electroless plating in this step is carried out, for example, by washing the base plate having an electroless plating catalyst with water to remove an unnecessary electroless plating catalyst (metal) and then immersing it in an electroless plating bath. Any electroless plating bath commonly known in the art may be used as the electroless plating bath.

When the base plate having an electroless plating catalyst precursor is immersed in an electroless plating bath while the electroless plating catalyst precursor is adsorbed on or impregnated into the graft polymer, the base plate is immersed in an electroless plating bath after washing it with water for removal of unnecessary precursors (metal salt or the like). In this case, reduction of the precursor and the subsequent electroless plating are carried out in the electroless plating bath. Similarly to the above, any electroless plating bath commonly known in the art may be used as the electroless plating bath used here.

Common electroless plating baths have a composition mainly containing 1. a plated metal ion, 2. a reducing agent, and 3. an additive (stabilizer) for stabilization of the metal ion. In addition to the above, the plating bath may also contain any known additives such as a stabilizer of the plating solution and the like.

The metals used in the electroless plating bath include copper, tin, lead, nickel, gold, palladium, and rhodium, and among them, copper and gold are particularly preferable from the point of conductivity.

The optimum reducing agent and additives are selected according to the metal. For example, a copper electroless plating bath contains Cu(SO₄)₂ as copper salt, HCOH as reducing agent, and a chelating agent such as EDTA and a Rochelle salt (stabilizer for copper ion) as additives. Alternatively, a plating bath used for electroless plating of CoNiP contains cobalt sulfate and nickel sulfate as the metal salts, sodium hypophosphite as reducing agent, and sodium malonate, sodium malate, sodium succinate as complexing agents. Still alternatively, a palladium electroless plating bath contains (Pd(NH₃)₄)Cl₂ as metal ion, NH₃ and H₂NNH₂ as reducing agent, and EDTA as stabilizer. These plating baths may also contain components other than the components above.

The thickness of the metal film thus formed can be adjusted by controlling the concentration of the metal salt or ion in plating bath, immersion time in plating bath, or the temperature of plating bath, or the like, and is preferably 0.5 μm or more and more preferably 3 μm or more from the point of conductivity.

The immersion time in the plating bath is preferably about 1 minute to 6 hours and more preferably about 1 minute to 3 hours.

SEM observation of the cross section of the metal film thus obtained revealed that there are a great number of fine particles of electroless plating catalyst and plated metal tightly dispersed in the surface graft layer (polymer layer) and that the plated metal is further deposited on the graft layer. Because the interface between the base plate and the metal film (plated layer) is in a hybrid state of the graft polymer and the fine particles, the adhesiveness is better even when the irregularity of the interface surface between the base plate (organic component) and the inorganic matters (electroless plating catalyst and plated metal) is 500 nm or less. Details of the condition of the cross section is the same as that described in detail in the explanation of the metal film as mentioned above.

### <Electroplating Step>

The metal film forming method according to the invention may have an additional step (d) for electroplating (electroplating step) after the step (c) above. In this step, after the electroless plating step (c) above, the metal film formed in the previous step is electroplated by using the film as an electrode. This allows easier formation of an additional new metal film with a desirable thickness on the basis of the metal film which is superior in adhesiveness to the base plate. Addition of this step, which expands the thickness of the metal film to a desirable value, is advantageous in applying the metal film according to the invention to various applications.

Any hitherto known method may be used as the electroplating method in the invention. Metals used in the electroplating in this step include copper, chromium, lead, nickel, gold, silver, tin, zinc, and the like, and copper, gold, and silver are preferable and copper is more preferable from the point of conductivity.

The thickness of the metal film obtained after electroplating varies according to applications and can be controlled by adjusting the concentration of the metal contained in the plating bath, immersion time, electric current density, or the like. The thickness of the common films used, for example, for electric wiring is preferably 0.5 μm or more and more preferably 3 μm or more from the point of conductivity.

In the present invention, from the viewpoint of increasing adhesiveness, it is preferable to conduct a drying step after the step (c) (electroless plating step) or step (d) (plating step) is conducted.

The drying process in the drying step can use any means such as natural drying, heat drying, reduced pressure drying, reduced pressure heat drying, and air drying. Among them, the drying process is preferably carried out at or around ordinary temperature in view of preventing deterioration of the polymer layer due to the drying process. More specifically, after the completion of the step (c) or (d), materials having the metal film formed thereon are preferably subjected to natural drying of being preserved under normal temperature atmosphere, drying under reduced pressure at normal temperature, and air-drying at normal temperature. In order to remove water contained as much as possible without heating, these drying processes are performed for one hour or more, preferably 24 hours or more. The drying condition can suitably be selected taking into account the adhesiveness required. Specifically, for example, materials having the metal film formed thereon are preserved for about 1 to 3 days, about 1 to 3 weeks or about 1 to 2 months under temperatures at about 25° C., or preserved under reduced pressure by a normal vacuum dryer for about 1 to 3 days or about 1 to 3 weeks.

Although the action in which the drying treatment can improve the adhesiveness is not clear enough, it is assumed that sufficient drying can prevent water, which may deteriorate the adhesiveness, from remaining in the metal film, whereby deterioration of adhesiveness with time due to water can be reduced.

In order to prevent oxidation of the surface of the metal film made of cupper or the like during the drying step, it is preferable to apply an antioxidant on the surface of the metal film. As the antioxidant, a generally-used antioxidant can be applied, for example, azimidobenzene or the like can be used.

### EXAMPLES

Hereinafter, the present invention will be described in more detail with referring to Examples, however it is not intended that the invention be limited to the illustrated Examples.

### Example 1

### Production of Base Plate

The following polymerization initiating layer coating solution was applied onto a polyimide film (trade name: Kapton, manufactured by Du Pont Toray Co., Ltd.) by using a rod bar #18, and was dried at 80° C. for 2 minutes.

The resulting film was preliminarily cured by irradiating light for 10 minutes by using a 400 W high pressure mercury lamp (UVL-400 P, manufactured by Riko Kagaku Sangyo Co., Ltd.) to form the polymerization initiating layer on the base material. The obtained polymerization initiating layer had a thickness of 6.5 μm.

The polyimide film, a base material, was found having Rz of 15 nm calculated according to JIS B 0601 from the measured values of the range of 40 μm×40 μm by Nanopics 1000 (manufactured by Seiko Instruments Inc.). The same measurement was carried out for the case the polymerization initiating layer was formed on the polyimide film to find that Rz was 10 nm and that the surface roughness of the base plate employed for Examples was within the preferable range of the invention.

### <Coating Solution for the Polymerization Initiating Layer>

Aryl methacrylate/methacrylic acid copolymer 4 g;
(Molar ratio 80/20, molecular weight 100,000)
Ethylene oxide-modified bisphenol A diacrylate 4 g
(trade name: M210, manufactured by Toagosei Co., Ltd.);
1-Hydroxycyclohexyl phenyl ketone 1.6 g; and
1-Methoxy-2-propanol 16 g.

### [Formation of Graft Polymer]

The polyimide film on which the polymerization initiating layer was formed in the above-mentioned manner was immersed in an aqueous solution containing acrylic acid (10% by mass) and sodium periodate (NaIO₄, 0.01% by mass) and irradiated with light for 10 minutes using the above-mentioned 1.5 kW high pressure mercury lamp in argon atmosphere. After the light irradiation, the obtained film was washed with ion exchanged water to obtain a base plate 1 on which the acrylic acid was grafted.

The Rz of the base plate 1 was measured in the same manner as in the case of the polyimide film to find it was 15 nm.

### [Electroless Plating]

The obtained base plate 1 was immersed in an aqueous solution of 0.1% by mass of palladium nitrate (manufactured by Wako Pure Chemical Industries, Ltd.) for 1 hour and washed with distilled water. After that, electroless plating was carried out in an electroless plating bath of the following composition for 10 minutes to produce the metal film 1.

### <Composition of the Electroless Plating Bath>

Copper sulfate 0.3 g;
NaK tartrate 1.7 g;
Sodium hydroxide 0.7 g;

### Formaldehyde 0.2 g; and

### Water 48 g

### Example 2

The metal film 1 obtained in Example 1 was further electroplated for 15 minutes in an electroplating bath of the following composition to produce a metal film 2.

### <Composition of the Electroplating Bath>

Copper sulfate 38 g;
Sulfuric acid 95 g;
Hydrochloric acid 1 mL;
Copper Gleam PCM (manufactured by Meltex Co., Ltd.) 3 mL; and

### Water 500 g

### (Fine Particle Dispersion State in the Polymer Layer Having the Metal Film Formed Thereon)

In Example 2, the fine particle dispersion state in the polymer layer on which the metal film was formed was observed. The detail was as follows.

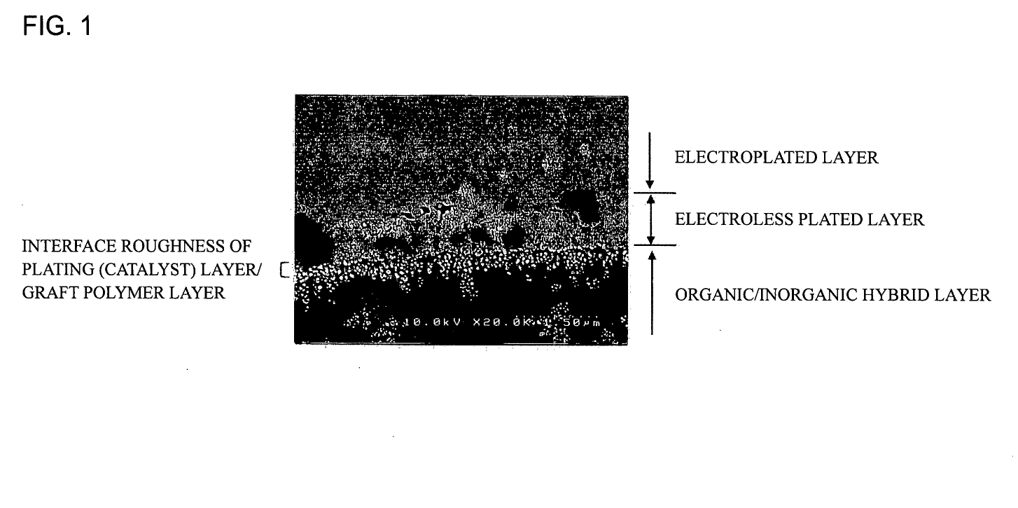

A region where the metal film was formed was cut by a diamond cutter (trade name: Sumiknife) using a microtome (manufactured by Leika Co., Ltd.) to obtain a sample having a clean plating cross-section. The obtained sample was observed by SEM to confirm the dispersion state of the fine particles in the polymer adjacent to the metal film. FIG. 1 is the SEM photograph of the cross-sectional view of the metal film 2 obtained in Example 2.

From the photograph of FIG. 1, it was confirmed that the fine particles supposedly made of at least one of the electroless plating catalyst and a metal deposited by the electroless plating exist with high density in the polymer layer in the vicinity of the interface with the metal film. Fine particles were scarcely observed in the deep part (the vicinity of the base plate) in the polymer layer.

Next, with respect to the SEM photograph, the image processing was carried out by Photoshop (manufactured by Adobe Inc.). The content of the image processing was as following.

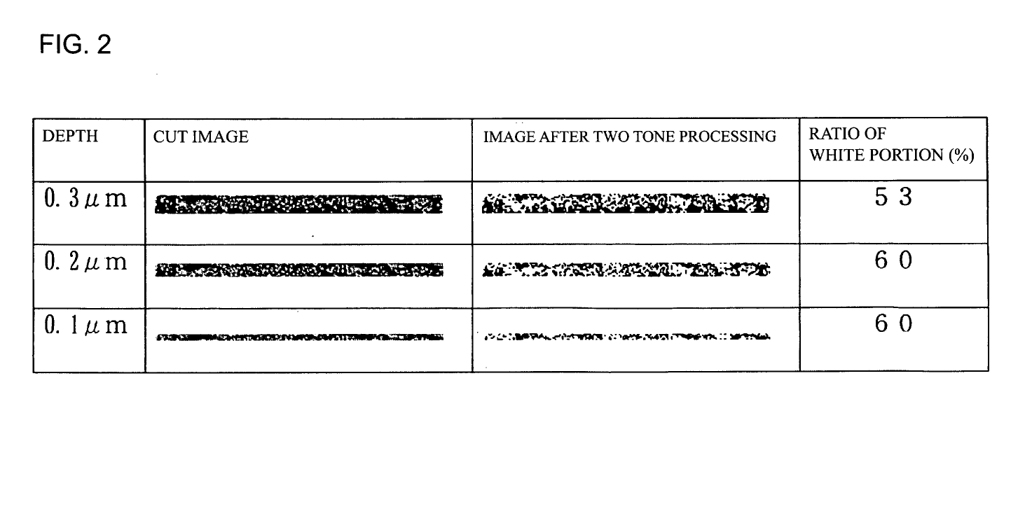

Three images with respective depths of 0.1 μm, 0.2 μm, and 0.3 μm from the interface between the polymer layer (shown as the organic/inorganic hybrid layer in FIG. 1) and the metal film (the electroless plated layer) were cut out within a range of 6 μm width, and the respective cut images were subjected to two tone processing (image processing) to make the portions for fine particles white and the portions for the polymer black (two tone processing condition: threshold value in the boundaries; 100). The images obtained in such a manner are shown in FIG. 2.

After that, the ratio of the white portions in the respective depths in FIG. 2 was calculated by histogram of the image to determine the ratio of the fine particles in the polymer layer under the plated layer. The results are shown together with the obtained images in FIG. 2. As shown in FIG. 2, it was confirmed that the fine particles exist at high density at or around the interface between the polymer layer and the metal film.

### Example 3

### Formation of Graft Polymer

The coating solution of the following composition was applied to the base plate having the polymerization initiating layer formed thereon used in Example 1 by using a rod bar #18. The thickness of the obtained film was 0.8 μm. The same treatment was carried out for the back face.

### <Composition of the Coating Solution>

Polymer A having a polymerizable group (the synthesis method is described below) 0.25 g and

### Cyclohexanone 8.0 g

### <Synthesis Method of the Polymer A Having a Polymerizable Group>

### (Synthesis of Monomer A)

To a 500 mL three neck flask, 2-hydroxyethyl methacrylate 58.6 g was added and acetone 250 ml was further added and stirred. After pyridine 39.2 g and p-methoxyphenol 0.1 g were added, the mixture was cooled in an ice bath containing ice water. After the mixed solution was cooled to 5° C., 2-bromoisobutanoic acid bromide 114.9 g was dropwise added for 3 hours by a dropping funnel. After the completion of the dropwise addition, the mixture was taken out of the ice bath and stirred further for 3 hours. The mixed reaction solution was poured to water 750 ml and stirred for 1 hour. The water-mixed liquid was extracted three times with ethyl acetate 500 ml by using a separating funnel. The organic layer was washed successively with 1M hydrochloric acid 500 mL, an aqueous saturated sodium hydrogen carbonate 500 mL, and saturated salt water 500 mL. Magnesium sulfate 100 g was added to the organic layer, and the organic layer was dewatered and dried, and filtered. The solvent was removed with reduce pressure to obtain the monomer A 120.3 g.

Next, N,N-dimethylacetamide 40 g was added to a 1000 mL three neck flask and heated to 70° C. under nitrogen gas flow. An N,N-dimethylacetamide solution 40 g containing Monomer A 12.58 g, methacrylic acid 27.52 g, and V-601 (manufactured by Wako Pure Chemical Industries, Ltd.) 0.921 g was dropwise added thereto for 2.5 hours. After completion of the dropwise addition, the mixture was heated to 90° C. and stirred for further 2 hours. After being cooled to a room temperature, the reaction solution was poured to water 3.5 L to precipitate a polymer compound. The precipitated polymer compound was separated by filtration and washed with water and dried to obtain the polymer compound 30.5 g. The obtained polymer compound was subjected to the weight average molecular weight measurement by gel permeation chromatography (GPC) using polystyrenes as standardized substances to find that the weight average molecular weight was 124,000.

The obtained polymer compound 26.0 g and p-methoxyphenol 0.1 g were added to a 200 mL three neck flask and dissolved in N,N-dimethylacetamide 60 g and acetone 60 g and cooled in an ice bath containing ice water. After the mixed solution was cooled to 5° C. or less, 1,8-diazabicyclo[5.4.0]-7-undecene (DBU) 60.4 g was dropwise added by a dropping funnel for 1 hour. After completion of the dropwise addition, the ice water was taken away, and the mixture was stirred further for 8 hours. The resulting reaction solution was poured to water 2 L in which concentrated hydrochloric acid 17 mL was dissolved to precipitate the polymer having a polymerizable group. The precipitated polymer A having a polymerizable group was separated by filtration, washed with water, and dried to obtain the polymer A 15.6 g.

Next, the front and back faces of the base plate were exposed for 5 minutes by using the 1.5 kW high pressure mercury lamp. The films obtained thereafter were washed with a saturated sodium hydrogen carbonate solution to obtain a base plate 2 having the above-mentioned polymerizable group-containing polymer grafted in both faces.

The base plate 2 was subjected to the Rz measurement in the same manner as that for the above-mentioned polyimide film to find that the Rz was 14 nm.

### [Electroless Plating and Electroplating]

The obtained base plate 2 was immersed in an aqueous solution containing 10% by mass silver nitrate (manufactured by Wako Pure Chemical Industries, Ltd.) for 1 hour and washed with distilled water. After that, electroless plating was carried out for 10 minutes in an electroless plating bath of the following composition. Further, electroplating was carried out for 15 minutes in the electroplating bath used in Example 2 to form a metal film 3′.

### <Composition of Electroless Plating Bath>

Copper sulfate 4.5 g;

### Triethanolamine 8.0 g;

Polyethylene glycol 0.03 g;

### Formaldehyde 5.4 g;

Sodium hydroxide 2.7 g; and

### Water 300 g.

### Example 4

### Formation of Graft Polymer

The coating solution of the following composition was applied to the base plate having the polymerization initiating layer formed thereon used in Example 1 by using a rod bar #18. The thickness of the obtained film was 1.0 μm.

### <Composition of the Coating Solution>

Hydrophilic polymer B having a polymerizable group (the synthesis method is described below) 0.25 g;

### Water 5 g; and

### Acetonitrile 3 g

### <Synthesis Method of the Hydrophilic Polymer B Having a Polymerizable Group>

Poly(acrylic acid) (average molecular weight 25,000) 18 g was dissolved in DMAc 300 g and mixed with hydroquinone 0.41 g, 2-methacryloyloxyethyl isocyanate 19.4 g, and dibutyltin dilaurate 0.25 g and reaction was carried out at 65° C. for 4 hours. The acid value of the obtained polymer was 7.02 meq/g. After that, the carboxyl group of the polymer was neutralized with an aqueous 1N sodium hydroxide solution, and the resulting mixture was added to ethyl acetate to precipitate the polymer, which was well washed to obtain the hydrophilic polymer B having the polymerizable group.

The obtained film was exposed for 5 minutes by using the 1.5 kW high pressure mercury lamp. Thereafter, the obtained film was washed with water to obtain a base plate 3 having the grafted hydrophilic polymer B having the polymerizable group.

The base plate 3 was subjected to the Rz measurement in the same manner as that for the above-mentioned polyimide film to find that the Rz was 15 nm.

### [Electroless Plating and Electroplating]

The obtained base plate 3 was immersed in an aqueous solution containing 0.1% by mass silver nitrate (manufactured by Wako Pure Chemical Industries, Ltd.) for 5 minutes and washed with distilled water. After that, electroless plating was carried out for 10 minutes in the electroless plating bath employed in Example 3. Further, electroplating was carried out for 15 minutes in the electroplating bath used in Example 2 to form a metal film 4.

### Example 5

### Production of Base Plate

### <Synthesis of Polyimide Precursor (Polyamic Acid)>

As a diamine compound, 4,4′-diaminodiphenyl ether (28.7 mmol) was dissolved in N-methylpyrrolidone (30 mL) under nitrogen atmosphere and stirred at room temperature for 30 minutes. To the solution, 3,3′,4,4′-benzophenone tetracarboxylic acid dianhydride (28.7 mmol) was added and stirred at 0° C. for 5 hours. The reaction solution was again precipitated to obtain the polyimide precursor 1. The structure of the product was confirmed by ¹H-NMR and FT-IR.

The polyamic acid synthesized by the above-mentioned technique was dissolved in DMAc (manufactured by Wako Pure Chemical Industries, Ltd.) to obtain a 30% by mass solution. The obtained solution was applied to a glass base plate by using a rod bar #36, dried at 100° C. for 5 minutes, and heated for curing at 250° C. for 30 minutes, and the formed film was peeled off from the glass base plate to obtain a polyimide base material.

The obtained polyimide base material was subjected to the Rz measurement in the same manner as that for the above-mentioned polyimide film to find that the Rz was 450 nm and that the surface roughness was within a preferable range of the invention.

An intermediate layer similar to that in Example 1 was formed on one face (the front face) of the base material obtained as described above.

The base plate having the intermediate layer thus obtained was subjected to the Rz measurement in the same manner as that for the above-mentioned polyimide film to find that Rz was 400 nm and that the surface roughness was within a preferable range of the invention.

### [Formation of Graft Polymer]

Next, the coating solution used in Example 4 was applied to the intermediate layer formed by the technique as described above by using a rod bar #18. The thickness of the obtained film was 0.8 μm.

The obtained film was exposed for 5 minutes by using the 1.5 kW high pressure mercury lamp. Thereafter, the obtained film was washed with water to obtain a base plate 4 having the grafted polymer having the polymerizable group.

The base plate 4 was subjected to the Rz measurement in the same manner as that for the above-mentioned polyimide film to find that Rz was 420 nm.

### [Electroless Plating and Electroplating]

The obtained base plate 4 was immersed in an aqueous solution containing 0.1% by mass silver nitrate (manufactured by Wako Pure Chemical Industries, Ltd.) for 1 hour and washed with distilled water. After that, electroless plating was carried out for 20 minutes in the same electroless plating bath as in Example 3. Further, electroplating was carried out for 15 minutes in the electroplating bath used in Example 2 to form a metal film 5.

### Example 6

The metal film 2 obtained in Example 2 was subjected to air drying at room temperature for 1 month to obtain a metal film 6.

### Example 7

The metal film 4 obtained in Example 4 was vacuum-dried at room temperature for 2 weeks by using a vacuum pump (manufactured by Sato Vacuum Co., Ltd.) to obtain a metal film 7.

### Example 8

A copper clad laminate board (base plate: Glass epoxy; copper thickness: 12 μm; no plated-through hole) was coated with the low dielectric insulating polymer coating solution of the following composition by using a rod bar #20 and dried at 110° C. for 10 minutes to produce a low dielectric insulating base plate.

The obtained low dielectric insulating base plate was subjected to the Rz measurement in the same manner as that for the above-mentioned polyimide film to find that Rz was 120 nm.

### <Low Dielectric Insulating Polymer Coating Solution>

The coating solution was prepared by adding polyphenylene ether resin (PKN 4752, manufactured by Nippon G. E. Plastics Co., Ltd.) 50 g, 2,2-bis(4-cyanatophenyl)propane (ArocyB-10, manufactured by Asahi-Ciba Ltd.) 100 g, 9,10-dihydro-9-oxa-10-phosphaphenanthren-10-oxide (trade name: HCA-HQ, manufactured by Sanko Chemical Co., Ltd.) 28.1 g, a 17% diluted toluene solution of manganese naphthenate (Mn content: 6% by mass; manufactured by Nihon Kagaku Sangyo Co., Ltd.) 0.1 g, and 2,2-bis(4-glycidylphenyl)propane (trade name: DER 331 L, manufactured by Dow Chemical Co.) 88.3 g to toluene 183 g and dissolving them by heating at 80° C.

### [Formation of Graft Polymer]

A coating solution of the following composition was applied to the obtained low dielectric insulating base plate by using a rod bar #18 in the same procedure as in Example 4.

The thickness of the obtained film was 1.0 μm.
The hydrophilic polymer B having the polymerizable group 0.25 g;

### Water 5 g; and

### Acetonitrile 3 g.

The obtained film was exposed for 5 minutes by using the 1.5 kW high pressure mercury lamp. Thereafter, the obtained film was washed with water to obtain a base plate 5 having the grafted hydrophilic polymer B having the polymerizable group.

The base plate 5 was subjected to the Rz measurement in the same manner as that for the above-mentioned polyimide film to find that Rz was 100 nm.

### [Electroless Plating and Electroplating]

The obtained base plate 5 was immersed in an aqueous solution containing 0.1% by mass silver nitrate (manufactured by Wako Pure Chemical Industries, Ltd.) for 5 minutes and washed with distilled water. After that, electroless plating was carried out for 10 minutes in the electroless plating bath employed in Example 3. Further, electroplating was carried out for 15 minutes in the electroplating bath used in Example 2 to form a metal film 8.

### Example 9

The metal film 8 obtained in Example 8 was subjected to air drying at room temperature for 1 month to obtain a metal film 9.

### <Evaluation>

### (Adhesion Property)

The metal films 2 to 9 obtained in Examples 2 to 9 were scratched in 1 cm width by a cutter and the edges were peeled to carry out a 90-degree peeling experiment according to JIS C 6481 (Experimental instrument: Autograph, manufactured by Shimadzu Corp.).

With respect to the metal film 1 obtained in Example 1, a copper sheet (width: 1 cm and thickness: 0.1 mm) was stuck to the surface of the film by an epoxy type adhesive (trade name: Araldite, manufactured by Ciba-Geigy Corp.) and dried at 140° C. for 4 hours and the resulting metal film was subjected to the 90 degree-peeling experiment in accordance with JIS C 6481. The results are shown in the following Table 1.

### (Evaluation of the Roughness at the Interface of the Base Plate).

The metal films 1 to 9 obtained in Examples 1 to 9 were cut vertically to the base plate plane by using a microtome, and the cross-sections were observed by SEM to confirm the roughness of the interface of the plated film and plating catalyst layer with the graft polymer layer (the organic material layer). The evaluation method was carried out according to JIS B0601 and the roughness of each sample was calculated on the basis of the difference between the average value of the first maximum to the fifth maximum summits and the average value of the first minimum to the fifth minimum valleys within 10 μm width at the interface of the plated film and plating catalyst layer with the graft polymer layer (the organic material layer). The results are shown in the following Table 1.

TABLE 1

| | Adhesion | |
|---|---|---|
| | property | Interface roughness |
| | (kN/m) | of base plate |
| Example 1 | 0.30 | 100 nm or less |
| Example 2 | 0.36 | 100 nm or less |
| Example 3 | 0.30 | 100 nm or less |
| Example 4 | 0.32 | 100 nm or less |
| Example 5 | 0.33 | 500 nm or less |
| Example 6 | 1.00 | 100 nm or less |
| Example 7 | 0.50 | 100 nm or less |
| Example 8 | 0.35 | 100 nm or less |
| Example 9 | 0.52 | 100 nm or less |

According to the results of the above Table 1, the respective metal films obtained in Examples 1 to 9 were found all having a interface roughness of the base plate (roughness of the interface of the plated metal and plating catalyst layer (inorganic components) with the base plate (organic components)) of 500 nm or less and thus excellent in surface smoothness, and also excellent in adhesion property between the base plate and the metal film.

Also, as shown in the results of Examples 6, 7, and 9, it was found that the adhesion property was remarkably improved by carrying out the drying step after the plating step.

As described above, according to the invention, a metal film excellent in adhesion property with a base plate can be provided. Also, according to the invention, a metal film formation method comprising easy steps, which permits the formation of a metal film excellent in adhesion property with a base plate and having a small roughness at the interface with the base plate, can be provided.

1. A metal film formed by applying an electroless plating catalyst or its precursor to a polymer layer on a base plate having a surface roughness of 500 nm or less and then carrying out electroless plating, the polymer layer comprising a polymer which has a functional group capable of interacting with the electroless plating catalyst or its precursor and is chemically bonded directly to the base plate, wherein the adhesion strength between the base plate and the metal film is 0.2 kN/m or more.

2. The metal film of claim 1, wherein the polymer layer has a region containing, in an amount of 25% by volume or more, dispersed fine particles of at least one of the electroless plating catalyst and a metal deposited by the electroless plating, in a thickness of 0.05 μm or more in the direction from the interface between the polymer layer and the metal film toward the base plate.

3. The metal film of claim 1, wherein the base plate is a base plate made of an insulating resin having a dielectric loss tangent of 0.01 or less at 1 GHz or a base plate comprising a layer made of the insulating resin on a base material.

4. The metal film of claim 1, wherein the base plate is a base plate made of an insulating resin having a dielectric constant of 3.5 or less at 1 GHz or a base plate comprising a layer made of the insulating resin on a base material.

5. A formation method of a metal film comprising the steps of:
(a) introducing, on a base plate having a surface roughness of 500 nm or less, a polymer which has a functional group capable of interacting with an electroless plating catalyst or its precursor and is capable of being chemically bonded directly to the base plate;
(b) applying the electroless plating catalyst or its precursor to the polymer; and
(c) carrying out electroless plating.

6. The formation method of claim 5, wherein the step (a) comprises the steps of:
(a-1) producing a base plate in which a polymerization initiating layer containing a polymerization initiator is formed on a base material having a surface roughness of 500 nm or less; and
(a-2) introducing, on the base plate in which the polymerization initiating layer is formed, a polymer which has a functional group capable of interacting with an electroless plating catalyst or its precursor and is capable of being chemically bonded directly to the base plate.

7. The formation method of claim 6, wherein the step (a-2) comprises bringing a polymer which has a polymerizable group and a functional group capable of interacting with an electroless plating catalyst or its precursor into contact with the base plate in which the polymerization initiating layer is formed, followed by applying energy thereto to chemically bond the polymer directly to the entire surface of the base plate.

8. The formation method of claim 5, further comprising the step of (d) carrying out electroplating after the step (c).

9. The formation method of claim 5, further comprising a drying step after the step (c).

10. The formation method of claim 8, further comprising a drying step after the step (d).

11. The metal film of claim 2, wherein the base plate is a base plate made of an insulating resin having a dielectric loss tangent of 0.01 or less at 1 GHz or a base plate comprising a layer made of the insulating resin on a base material.

12. The metal film of claim 2, wherein the base plate is a base plate made of an insulating resin having a dielectric constant of 3.5 or less at 1 GHz or a base plate comprising a layer made of the insulating resin on a base material.

13. The metal film of claim 3, wherein the base plate is a base plate made of an insulating resin having a dielectric constant of 3.5 or less at 1 GHz or a base plate comprising a layer made of the insulating resin on a base material.

14. The metal film of claim 11, wherein the base plate is a base plate made of an insulating resin having a dielectric constant of 3.5 or less at 1 GHz or a base plate comprising a layer made of the insulating resin on a base material.

15. The formation method of claim 6, further comprising the step of (d) carrying out electroplating after the step (c).

16. The formation method of claim 7, further comprising the step of (d) carrying out electroplating after the step (c).

17. The formation method of claim 6, further comprising a drying step after the step (c).

18. The formation method of claim 7, further comprising a drying step after the step (c).
